(19) United States
(12) Patent Application Publication
(10) Pub. No.: US 2004/0194731 A1
(43) Pub. Date: Oct. 7, 2004

(54) Decorative scratching post

(76) Inventor: Christopher J. Lineberry, Franklin, MA (US)

Correspondence Address: AKC PATENTS, 215 GROVE ST., NEWTON, MA, 02466, US

(21) Appl. No.: 10/794,466

(22) Filed: Mar. 5, 2004

Related U.S. Application Data
(60) Provisional application No. 60/452,575, filed on Mar. 6, 2003.

(51) Int. Cl. E04H 1/00; A01K 15/02

(52) U.S. Cl. 119/706

(57) ABSTRACT

A scratching post assembly for household pets includes a decorative base, a post having a first end attached to the decorative base and a decorative top adapted to be removably attached to a second end of the post. The post is substantially covered with a removable cover made of scratchable material. The cover comprises a tube that is sized to fit around and be slipped over the post and to adapt to the post's geometric shape. The decorative base and decorative top are made of decorative materials including, wood, stone, glass, metal, ceramic, fabric, engineered versions thereof or combinations thereof. The decorative base and top may also include decorative finishes and designs, including sculptured surfaces, trim, engravings, paint, stain, beading and metals plates, among others. The invention provides an aesthetically pleasing scratching post that blends with designer style furniture and adapts to various fashions and trends in the furniture industry.

### Cross Reference to related Co-Pending Applications

This application claims the benefit of U.S. provisional application Serial No. 60/452,575 filed on Mar. 6, 2003 and entitled SCRATCHING POST which is commonly assigned and the contents of which are expressly incorporated herein by reference.

### FIELD OF THE INVENTION

The present invention relates to a decorative scratching post for household pets, and more particularly to a decorative scratching post with a replaceable cover.

### BACKGROUND OF THE INVENTION

This invention addresses the need for household pets, specifically domesticated cats, to have a post to scratch as an alternative to other items in the house like furniture, rugs and other decorative fabrics.

Scratching posts are well known in the art and have been available for some time in the pet product market. A typical scratching post as described by Yoder in U.S. Pat. No. 2,005,817 includes a base and a post wrapped with a carpet-like cover that can be scratched by a cat. The post may also contain pockets filled with a substance having an odor attractive to cats. The carpet-like cover may be replaceable as is the case in US 2002/0195064 patent application.

Scratching posts are frequently placed in living rooms, dining rooms, bedrooms, or other rooms in a house that are furnished with designer style furniture. Most of the available scratching posts are not aesthetically attractive and are made of materials that clash with the designer style furniture. The scratching posts become especially unattractive when the cover material is worn out.

Accordingly, there is a need for an aesthetically pleasing scratching post that blends with designer furniture and adapts to various fashions and trends in the furniture industry.

### SUMMARY OF THE INVENTION

In general, in one aspect, the invention features a scratching post assembly for household pets including a decorative base, a post extending from the decorative base and a decorative top adapted to be removably attached to the post. The post includes an elongated body, a first end, a second end and a cover made of scratchable material substantially covering the body and being removably attached to the body. The first end of the post is attached to the decorative base and the second end is removably attached to the second end of the post.

Implementations of this aspect of the invention may include one or more of the following features. The decorative base and decorative top may be made of wood, stone, glass, metal, ceramic, plastic, fabric, engineered versions thereof, or combinations thereof. The wood may be cherry, walnut, mahogany, birch, red birch, pine, maple, or engineered versions thereof. The decorative base and decorative top may further include decorative finishes such as sculptured surfaces, trim, engravings, paint, stain, decorative designs, beading, or metal hardware. The decorative designs may have a theme such as nautical, Christmas, Valentine's day, patriotic, botanical, animal, seasonal, or other holiday type themes. The cover may have a tubular shape and may be sized to fit around and be slipped over the body and to adapt to the body's geometric shape. The tubular shaped cover may be formed by attaching two opposite sides of a rectangular piece of the scratchable material by sewing, stapling, gluing, taping, using hook and loop type material, or using snap buttons, hooks, or pins. The cross-section of the body may be a circle, oval, trapezoid, square, rectangular, triangle or polygon. The geometric shape of the decorative base and decorative top may be circular, oval, square, rectangular, triangular, polygonal, hemispherical, conical, or pyramidal. The decorative top may be used as a tabletop or as a sitting element. The cover is preferably slipped over the body and is held in position by friction. Alternatively, the cover is secured in position by the decorative top or may be removably attached to the body via a fastening such as an adhesive, adhesive tape, hook and loop material, snap buttons, removable pins, hooks, or staples. The scratching post assembly may further include one or more holes formed within the body for containing a substance attractive to household pets. The top may be removably attached to the second end of the post via a decorative hardware. The decorative hardware may be a decorative screw, a decorative pin, or a decorative plate. The decorative top may have an opening sized to fit over an appendage extending from the second end of the post, thereby providing the removable attachment to the body. Alternatively, the decorative top may haves an appendage sized to fit within a hole formed on the second end of the post, thereby providing the removable attachment to the body.

In general, in another aspect, the invention features a scratching post assembly including a decorative base, a post extending from the decorative base and a decorative top adapted to be removably attached to the post. The post includes an elongated body, a first end, a second end and a cover made of scratchable material substantially covering the body and being removably attached to the body. The cover comprises a tube sized to fit around and be slipped over the body and to adapt to the body's geometric shape. The tube is formed by attaching two opposite sides of a rectangular piece of the scratchable material by sewing, stapling, gluing, taping, using hook and loop type material, or using snap buttons, hooks, or pins.

In general, in another aspect, the invention features a method of producing a scratching post assembly for household pets including the following steps. First, providing a decorative base. Next providing a post extending from the decorative base and having an elongated body, a first end, and a second end, and then attaching the first end to the decorative base. Next, forming a tubular shaped cover by attaching two opposite sides of a rectangular piece of scratchable material. Next, slipping the tubular shaped cover over the elongated body. Next, providing a decorative top and removably attaching it to the second end of the post. The tubular shaped cover is sized to fit around and be slipped over the body and to adapt to the body's geometric shape. Furthermore, the tubular shaped cover has a length sized to substantially cover the elongated body.

Among the advantages of this invention may be one or more of the following. The invention provides a decorative scratching post that is made of materials and includes decorative finishes that blend with designer style furniture and adapt to various fashions and trends in the furniture industry. This current design also incorporates a replaceable cover, made out of various materials suitable for scratching, that is manufactured as a sleeve or cylinder open at both ends. This allows the user to easily slide the worn cover off and replace it with a new cover that simply slips over the post. The top piece is removable in order to gain access to the cover for replacement. The cover itself is very simple and inexpensive to manufacture and use, unlike other designs.

The details of one or more embodiments of the invention are set forth in the accompanying drawings and description below. Other features, objects and advantages of the invention will be apparent from the following description of the preferred embodiments, the drawings and from the claims.

### BRIEF DESCRIPTION OF THE DRAWINGS

Referring to the figures, wherein like numerals represent like parts throughout the several views:

FIG. 1 is perspective view of the scratching post including a decorative base, a column, a decorative top and a pattern representing the replaceable cover;

FIG. 2 is a front view of the scratching post of FIG. 1;

FIG. 3 is a cross sectional side view of the scratching post of FIG. 1;

FIG. 4 is a is a top view of the decorative base of FIG. 1;

FIG. 5 is a side view of the decorative base of FIG. 1;

FIG. 6 is a top view of the decorative top of FIG. 1;

FIG. 7 is a side view of the decorative top of FIG. 1;

FIG. 8 is a top cross sectional view of the column of FIG. 1;

FIG. 9 is a side cross sectional view of the column of FIG. 1;

FIG. 10 is a top view of the replaceable sleeve-like cover;

FIG. 11is a front view of the replaceable, sleeve-like cover;

FIG. 12 is a perspective view of the replaceable sleeve-like cover;

FIG. 13 is a front view of the piece of material used to form the sleeve-like cover of FIG. 12;

FIG. 14A is a side cross-sectional view of another embodiment of a scratching post according to this invention;

FIG. 14B is a side cross-sectional view of another embodiment of a scratching post according to this invention;

FIG. 15A is a side cross-sectional view of an alternative attachment of the decorative top to the post; and

FIG. 15B is a side cross-sectional view of another alternative attachment of the decorative top to the post.

### DETAILED DESCRIPTION OF THE INVENTION

The invention provides a scratching post for domesticated cats that has a very easy to use and inexpensively manufactured replaceable sleeve-like cover. The main components of the post namely the top and base are made of solid materials, such as wood, granite, marble, ceramic, glass, or metal. The top and base can be finished in a number of ways and will keep the scratching post attractive for many years. The part that does wear with use, the sleeve-like cover, can be replaced quickly and easily by the user and because of its simple and unique design, can be manufactured at low cost.

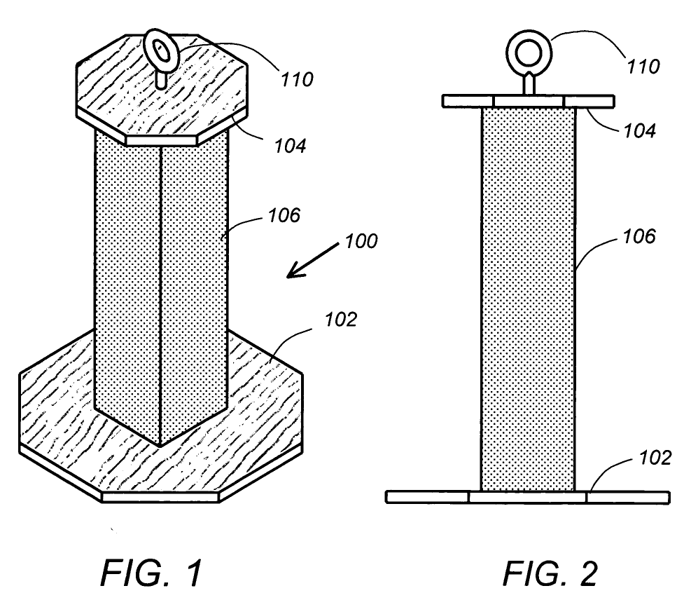

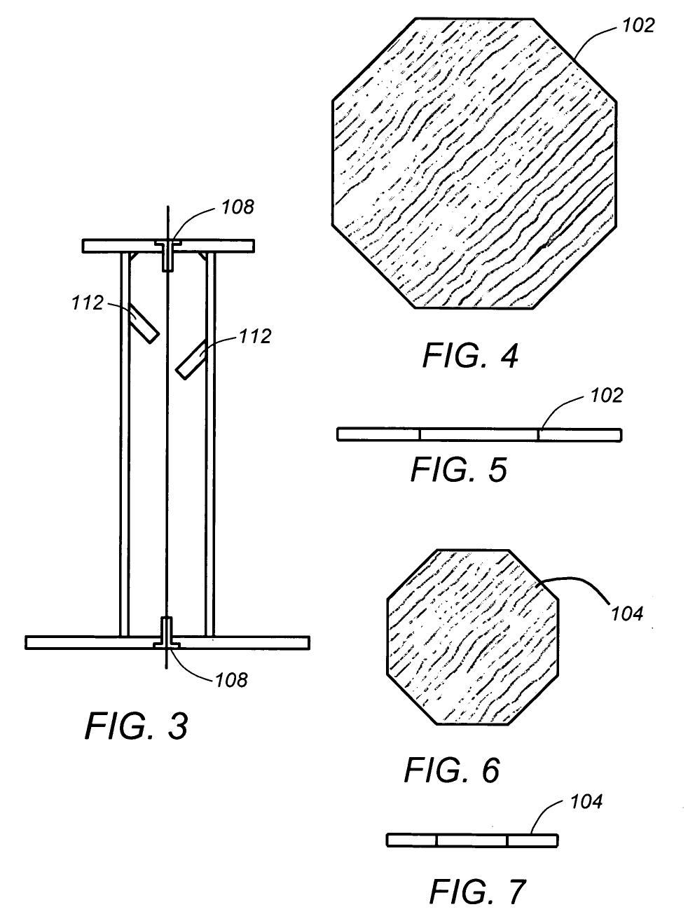

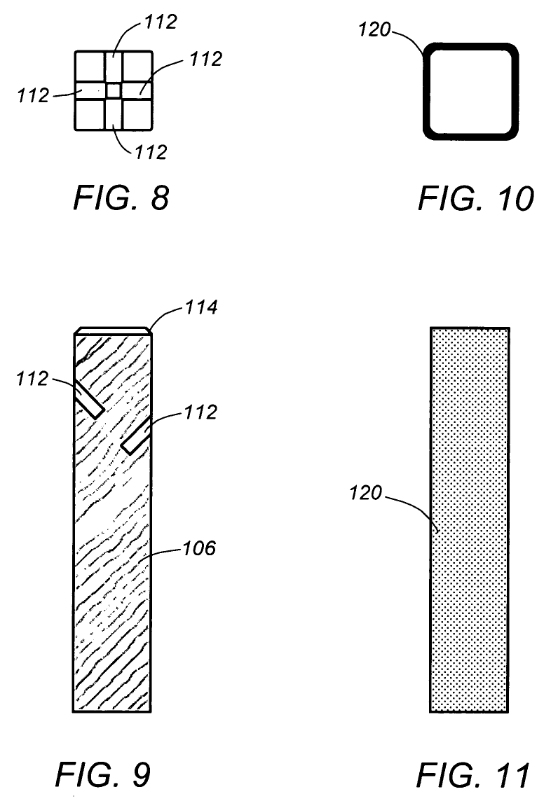

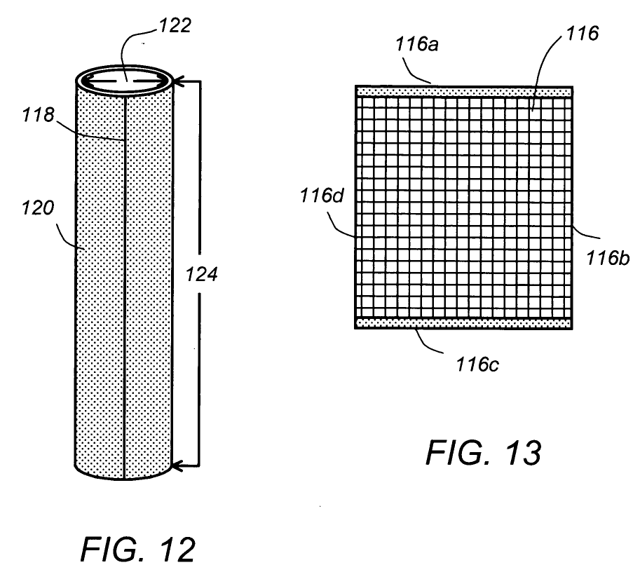

Referring to FIG. 1, the scratching post 100 includes an attractive ornamental hardwood base 102, a column 106, and an attractive ornamental hardwood top 104. Column 106 is mounted on the base 102 with hardware 108, shown in FIG. 3. FIG. 2 is a front view showing an optional ornamental hardware 110 item used to secure top 104 to column 106. Referring to FIG. 3, hardware 108 is used to secure top 104 to column 106 and base 102 to column 106, as shown. FIGS. 4-7 show various angles of the ornamental hardwood top 104 and base 102. Referring to FIG. 8, holes 112 are drilled into each side of the column 106 at 45-degree angles and at various heights to contain catnip. FIG. 9 shows only the column without base, top or cover. Note the chamfer 114 at the top of column 112 to aid in the installation of the replaceable sleeve-like cylindrical cover 120. The cover 120 is shown in FIG. 10 from the top and in FIG. 11 from the front. A perspective view of cover 120 is shown in FIG. 12. A piece of material 116 is cut having parallel opposite sides, i.e., side 116a parallel to side 116c, and side 116b parallel to side 116d, shown in FIG. 13. Two parallel opposite sides, i.e., 116b and 116d, are sewn together to form the cylindrical shaped cover 120. A seam 118 is formed along the line where the opposite parallel sides 116b, 116d are sewn. The other two opposite parallel sides 116a and 116c are bound and form the top and bottom of the cylindrical cover 120, respectively. The cover can be made out of carpet or other material that the feline can scratch. The seam 118 may be invisible, and there may be more than one seam. Alternatively, the two parallel opposite sides, i.e., 116b and 116d, may be taped, stapled, glued, attached with Velcro, or otherwise secured together to form the cylindrical shaped cover 120.

The top 104 and base 102 may have a polygonal, circular, spherical or other geometric shapes. The base 102 and top 104 may be made of hardwood including mahogany, cherry, walnut, birch, pine, and other types of wood. The base and top may be also made of glass, metal, ceramic, stone, granite, or any other decorative type of material. The base and top material is chosen so as to match the general decor, style, and other type of furniture that the pet owners have in their homes. The cover can be easily replaced by first removing the hardware 108, then removing the top 104, and then removing the worn-out cover 120. Next, a piece of the cylindrical shaped material 120 having the appropriate diameter 122 and the appropriate height 124, so as to match the height of the column 106, is slipped over the column 106, and then the top 104 is secured on the top of the column 106 with the hardware 108. The cover 120 may have designs, prints, colors and texture that match a certain decoration theme. Examples of such decoration themes include, Christmas, nautical, Valentine's Day, patriotic, botanical, animal, or any other special holiday type theme. The column 106 may have any polygonal or cylindrical shape. In one example the column 106 has a square cross-section with a side of 4 inches and a height of 20 inches. The top 104 has an octagonal shape with a diameter of 8.5 inches and a height of 0.75 inches. The base is also octagonal with a diameter of 16 inches and a height id 0.75 inches.

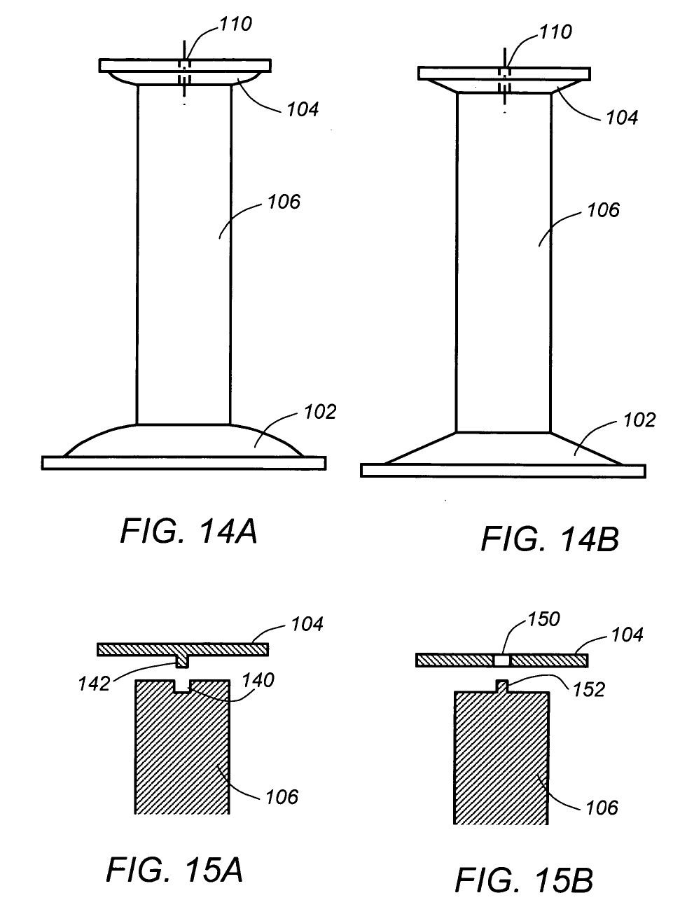

Other embodiments are within the scope of the following claims. For example, the top 104 and base 102 may have a hemispherical shape or a truncated pyramidal shape, as shown in FIGS. 14A and 14B, respectively. The 104 top may have an appendage 142 extending from a surface, and the column 106 may have an opening 140 for receiving the appendage 142, as shown in FIG. 15A. The top is then attached to the column by inserting the appendage 142 into the column opening 140. Alternatively, the top has an opening 150, the column has an appendage 152 and the top is attached to the column by inserting the column appendage 152 into the top opening 150. The top may further be secured on the column with a screw or a pin 108. The cover 120 is preferably held in place by friction or may be additionally secured by the decorative top 104. Alternatively the cover 120 may be removably attached to the post via a fastening such as an adhesive, adhesive tape, hook and loop material, snap buttons, removable pins, hooks, or staples.

Several embodiments of the present invention have been described. Nevertheless, it will be understood that various modifications may be made without departing from the spirit and scope of the invention. Accordingly, other embodiments are within the scope of the following claims.

What is claimed is:

1. A scratching post assembly for household pets comprising:
a decorative base;
a post extending from said decorative base and comprising an elongated body, a first end, a second end and a removable cover made of scratchable material substantially covering said body and wherein said first end is attached to said decorative base; and
a decorative top adapted to be removably attached to said second end of said post.

2. The scratching post assembly of claim 1 wherein said cover comprises a tube and said tube is sized to fit around and be slipped over said body and to adapt to said body's geometric shape.

3. The scratching post assembly of claim 2 wherein said tube is formed by attaching two opposite sides of a rectangular piece of said scratchable material by a method selected from a group consisting of sewing, stapling, gluing, taping, using hook and loop type material, and using snap buttons, hooks, or pins.

4. The scratching post assembly of claim 1 wherein said decorative base and decorative top are adapted to be modified to follow various fashions and trends in the furniture industry.

5. The scratching post assembly of claim 1 wherein said decorative base and said decorative top comprise a material selected from a group consisting of wood, stone, glass, metal, ceramic, plastic, fabric, engineered versions thereof, and combinations thereof.

6. The scratching post assembly of claim 5 wherein said decorative base and said decorative top comprise wood selected from a group consisting of cherry, walnut, mahogany, birch, red birch, pine, maple, and engineered versions thereof.

7. The scratching post assembly of claim 6 wherein said decorative base and said decorative top further comprise decorative finishes selected from a group consisting of sculptured surfaces, trim, engravings, paint, stain, decorative designs, beading, and metal hardware.

8. The scratching post assembly of claim 7 wherein said decorative designs comprise a theme selected from a group consisting of nautical, Christmas, Valentine's day, patriotic, botanical, animal, seasonal, and other holiday type themes.

9. The scratching post assembly of claim 1 wherein said body comprises a geometric shape having a cross-section selected from a group consisting of circle, oval, trapezoid, square, rectangular, triangle and polygon.

10. The scratching post assembly of claim 1 wherein said decorative base and decorative top comprise a geometric shape selected from a group consisting of circular, oval, square, rectangular, triangular, polygonal, hemispherical, conical, and pyramidal.

11. The scratching post assembly of claim 1 wherein said decorative top is used as a tabletop.

12. The scratching post assembly of claim 1 wherein said decorative top is used as a sitting element.

13. The scratching post assembly of claim 1 wherein said cover is held in place by friction.

14. The scratching post of claim 1 wherein said cover is held in place by said decorative top.

15. The scratching post assembly of claim 1 wherein said cover is removably attached to said body via a fastening selected from a group consisting of adhesive, adhesive tape, hook and loop material, snap buttons, removable pins, hooks, and staples.

16. The scratching post assembly of claim 1 further comprising one or more holes formed within said body for containing a substance attractive to said household pets.

17. The scratching post assembly of claim 1 wherein said top is removably attached to said second end of said post via a decorative hardware.

18. The scratching post assembly of claim 17 wherein said decorative hardware is selected from a group consisting of a decorative screw, a decorative pin, and decorative plate.

19. The scratching post assembly of claim 1 wherein said decorative top comprises an opening sized to fit over an appendage extending from said second end of said post, thereby providing said removable attachment to said body.

20. The scratching post assembly of claim 1 wherein said decorative top comprises an appendage sized to fit within a hole formed on said second end of said post, thereby providing said removable attachment to said body.

21. A scratching post assembly comprising:
a decorative base;
a post extending from said decorative base and comprising an elongated body, a first end, a second end and a removable cover made of scratchable material substantially covering said body and wherein said first end is attached to said decorative base;
a decorative top adapted to be removably attached to said second end of said post; and
wherein said cover comprises a tube sized to fit around and be slipped over said body and to adapt to said body's geometric shape and wherein said tube is formed by attaching two opposite sides of a rectangular piece of said scratchable material by a method selected from a group consisting of sewing, stapling, gluing, taping, using hook and loop type material, and using snap buttons, hooks, or pins.

22. A method of producing a scratching post assembly for household pets comprising:
providing a decorative base;
providing a post extending from said decorative base and comprising an elongated body, a first end, and a second end;
attaching said first end to said decorative base;
forming a tubular shaped cover by attaching two opposite sides of a rectangular piece of scratchable material, wherein said tubular shaped cover is sized to fit around and be slipped over said body, to adapt to said body's geometric shape, and comprises a length sized to substantially cover said elongated body;
slipping said tubular shaped cover over said elongated body;
providing a decorative top; and
removably attaching said decorative top to said second end of said post.
